(19) United States
(12) Patent Application Publication
(10) Pub. No.: US 2008/0272898 A1
(43) Pub. Date: Nov. 6, 2008

(54) Method and Device for Warning of a Collision

(76) Inventors: Albrecht Irion, Stuttgart (DE); Dirk Meister, Moeglingen (DE); Marc Arnon, Ingolstadt (DE)

Correspondence Address: KENYON & KENYON LLP, ONE BROADWAY, NEW YORK, NY, 10004, US

(21) Appl. No.: 11/885,478

(22) PCT Filed: Mar. 2, 2006
(86) PCT No.: PCT/EP2006/060396

§ 371 Date: Apr. 3, 2008

(30) Foreign Application Priority Data
Mar. 11, 2005 (DE) 102005011241.2

(51) Int. Cl. B60Q 11/00

(52) U.S. Cl. 340/436

(57) ABSTRACT

In a method for warning the driver of a motor vehicle about a danger of collision with objects located in front of the host vehicle in the traffic lane being traveled by the vehicle, a decision about the output of a warning is made based on a deceleration criterion that relates to the vehicle deceleration necessary for avoiding the collision. The method includes: checking an evasion criterion that relates to the time needed for an evasive maneuver in relation to the time remaining until the collision; activating a first warning stage when one of the two criteria—deceleration criterion and evasion criterion—is satisfied for at least one object; and activating a second warning stage when the second criterion is also satisfied for this object.

### BACKGROUND OF THE INVENTION

1. Field of the Invention

The present invention relates to a method for warning the driver of a motor vehicle about a danger of collision with objects located in front of the host vehicle in the traffic lane being traveled by the vehicle, and a decision about the output of a warning is made based on a deceleration criterion that relates to the vehicle deceleration necessary for avoiding the collision.

2. Description of Related Art

Motor vehicles are increasingly equipped with a sensor system, e.g., with radar sensors, video sensors and the like, by which the surroundings of the vehicle can be detected, so that various assistance and safety functions are made possible. A typical example of such an assistance function is the adaptive cruise control (ACC). In that case, the distance to a preceding vehicle is measured with the aid of a radar sensor, and the distance is regulated automatically by the cruise controller. An expedient supplement or further refinement of such a function is a warning function, which warns the driver about obstacles on the roadway. Since a radar sensor is able to measure relative velocities directly, while a human driver can only imprecisely estimate relative velocities, traffic safety is increased considerably by such a system.

However, the ACC systems used in practice until now react only to moving objects, thus, in particular, to other vehicles, while stationary objects are ignored. The reason is that the interpretation and evaluation of relevance in the case of stationary objects causes considerable difficulties since, for example, using a radar sensor, it is not readily possible based on the radar echo to distinguish an irrelevant object such as a can or the like lying on the road from a large object, for instance, a standing vehicle, which represents a real obstacle. Since until now, for the most part the ACC systems have been used only on expressways or well-enlarged highways on which, apart from rare exceptions, no stationary objects are on the roadway, the restriction to moving objects within the framework of the actual ACC function is acceptable. However, with regard to the warning function, it would be desirable to include stationary objects in the evaluation, as well.

There are various approaches by which it is possible to improve the evaluation of stationary objects, for example, by evaluating the object size, possibly in combination with a video system, by tracking the movement of preceding vehicles from the standpoint as to whether the preceding vehicle evades the stationary object or drives over it, and the like. Even then, however, the evaluation is still encumbered with certain drawbacks, so that false warnings cannot be ruled out. However, frequent false warnings impair the comfort and the feeling of safety for the driver and passengers, with the possible result that ultimately the warnings are no longer taken in earnest or the system is rejected altogether.

### A BRIEF SUMMARY OF THE INVENTION

The method of the present invention makes it possible to warn the driver about potential obstacles with the necessary insistence without excessive disturbance of comfort.

This is achieved according to the present invention by implementing the collision warning in at least two stages. Two different criteria are utilized for activating these two stages, namely, first of all, the deceleration criterion already mentioned that focuses on the vehicle deceleration which would be necessary to avoid a collision if no evasive maneuver were carried out, and on the other hand, a so-called evasion criterion, where an evasive maneuver is simulated and the time necessary for it is estimated and related to the time still available until the collision. If one of these two criteria is satisfied for at least one object, a relatively “mild” first warning stage is activated in which the potential danger is pointed out to the driver by a less annoying signal, for instance, by a warning light lighting up on the dashboard, by indication on a display or the like. Only when the second criterion is also satisfied for the object which triggered this first warning stage is a more emphatic second warning stage activated, in which the driver is then warned more intensely, for instance, by blinking of a warning light, by an audible signal or also by a haptic signal, for instance, in the form of a short-duration deceleration of the host vehicle or a decrease of acceleration.

Although it is expedient to combine the warning function described here with an ACC system, because it is then possible to fall back upon the functions of the ACC system for the locating of objects and for the evaluation of the dynamic data, nevertheless the warning function can also be active when the actual ACC function is switched off.

By the first warning stage, the driver is made aware in restrained form of a possible danger situation, so that his attention is increased, and he thus receives the possibility of accurately analyzing the traffic situation on his part and identifying the potential danger source. If, in so doing, the presence of an obstacle is confirmed, the driver is able to neutralize the situation by an early reaction, for instance, by a deceleration of the vehicle or by an evasive maneuver, so that the second warning stage does not need to be activated. On the other hand, if the driver recognizes that the supposed obstacle is an irrelevant object, for instance, a can or the like lying on the road, he can ignore the warning. Even if the warning system should then erroneously activate the second warning stage, it would not find the driver unprepared, and the more emphatic second warning stage will therefore not trigger a startle reaction in him. The disturbance of comfort is thereby considerably alleviated, and the acceptance of the system is improved. On the other hand, if the driver himself is uncertain in the evaluation of the traffic situation because, for instance, he is unable to estimate relative velocities with sufficient accuracy, the second warning stage gives him a clear indication that a reaction is necessary.

The method of the present invention permits not only the consideration of moving objects, but also in particular the consideration of stationary objects, it proving to be especially advantageous here that occasional false interpretations do not lead to a significant impairment of comfort.

An additional plausibility or relevance evaluation according to known algorithms and criteria may be provided for stationary objects. Several additional criteria which, according to the knowledge of the inventors, are proposed here for the first time, are indicated in the dependent claims and are explained in greater detail in the description of the exemplary embodiment.

For example, the following object properties and attributes, which are provided by the locating system, e.g., by the radar sensor, are evaluated for checking the deceleration criterion and the evasion criterion:
Position of the object inside or outside of the precalculated traffic lane of the host vehicle. Algorithms for predicting the traffic lane of the host vehicle are known. The assignment of an object to this traffic lane or to an adjacent lane is possible on the basis of a certain angular-resolution capability of the radar sensor.
Distance of the object to the host vehicle.
Relative velocity between the object and the host vehicle.
Deviation of the object course from that of the host vehicle.
Absolute acceleration of the object.
Status as to whether the object was measured in the current measuring cycle, or frequency with which the object was measured in successive measuring cycles.

In addition, data about the state of motion of the host vehicle may also be evaluated, especially the vehicle's own speed and the yaw velocity or lateral acceleration.

To check the deceleration criterion, on the basis of this data, for each located object within the traffic lane of the host vehicle, a deceleration value is calculated that corresponds to a suitable reaction to the obstacle. The deceleration criterion is considered to be satisfied when this deceleration value lies above a specific threshold value. The deceleration value may be calculated in known manner in light of the demand that the host vehicle can still be brought to a standstill in time in front of a stationary obstacle, or, in the case of moving objects, that its speed can be adapted in time to that of the object. In so doing, suitable safety distances, unavoidable reaction times and the like may be taken into account.

According to an alternative possibility, which may also be advantageous independently of the remaining features of the invention described here, the deceleration value is calculated on the basis of an empirical approach, using an algorithm whose parameters are established based on data ascertained empirically in advance, in such a way that the behavior of a human driver upon approaching an obstacle is portrayed.

In both cases, certain parameters of the algorithm may be adjustable by the driver, or may be adaptable within the framework of a learning algorithm, in order to achieve a system performance that corresponds to the individual habits and preferences of the driver. In known ACC systems, the driver usually has the possibility of selecting, within certain limits, the so-called time gap which indicates the time interval between the preceding vehicle tracked as the target object and the host vehicle. A small time gap means that the driver prefers a driving style with, more likely, a small safety distance that requires increased attentiveness, and for which possibly sharper vehicle decelerations must also be accepted. On the other hand, a larger time gap corresponds to a “more relaxed” driving style, with larger safety distance and, correspondingly, more moderate accelerations and decelerations. Therefore, it is useful to take this time gap into account when establishing the deceleration criterion as well, since as a rule, a driver who has selected a large time gap will also prefer an earlier warning about obstacles, and therefore a lower warning threshold.

To check the evasion criterion, initially the anticipated time until the collision is calculated on the basis of the dynamic data, by extrapolating the instantaneous relative acceleration between the object and the host vehicle into the future. Furthermore, the time that the driver would need for an evasive maneuver by steering is calculated. To that end, the path the vehicle would travel through during the evasive maneuver is approximated geometrically and its length is calculated. Based on the absolute velocity of the host vehicle, it is then possible to calculate the time needed for traversing this distance. In calculating the evasion course, a suitable value for the lateral acceleration of the host vehicle that is possible or regarded as acceptable is taken as a basis. If desired, this value may also be a function of velocity.

The evasion criterion is regarded as satisfied when the difference between the time until the collision and the time needed for the evasive maneuver is less than a predetermined threshold value. Optionally, the time gap or an empirically determined parameter may again be taken into consideration when fixing this threshold value, as well.

Since with the aid of the radar system, it is also possible to track the traffic in the adjacent lanes, it is expedient within the framework of the evasion criterion to also check whether the traffic in the adjacent lanes even allows an evasive maneuver. For instance, if a slower preceding vehicle is in the adjacent lane available for the evasive maneuver, a variant of the deceleration criterion may also be applied to this vehicle, so that a further deceleration value is obtained which takes into account a possible lane change by the driver of the host vehicle, and which in particular would have to be taken into consideration upon triggering of the second warning stage.

By suitable selection of the threshold values and parameters in checking the deceleration criterion and the evasion criterion, it is possible to determine which of these two criteria will more likely be satisfied. The criterion satisfied first will trigger the first warning stage. According to a preferred specific embodiment, the deceleration criterion is the weaker criterion which triggers the first warning stage, and the second warning stage is triggered when the stronger evasion criterion is also satisfied.

A constant warning signal may be output at least in the first warning stage, that is, the warning signal lasts so long as the criterion in question is satisfied for at least one object. In the second warning stage as well, a constant warning signal, for instance, in the form of a blinking warning light, may be output during the time in which both criteria are satisfied.

Advisably, additional circumstances are also taken into account in the activation and cancellation of the warning stages. For example, it is expedient for objects whose distance is greater than a predefined maximum distance to be ruled out from the evaluation from the start, so that these objects will not trigger any warning. In the same way, it is expedients to deactivate the warning system when the absolute velocity of the host vehicle lies below a specific limiting value. When, after activation of the first or second warning stage, the driver reacts to the danger situation, for instance, by actuating the brake pedal, both warning stages may be canceled. Correspondingly, the first warning stage may be suppressed when, at the moment at which the criterion in question is satisfied for the first time, the driver is already holding the brake pedal depressed.

### BRIEF DESCRIPTION OF THE SEVERAL VIEWS OF THE DRAWING

FIGS. 1-3 show various parts of a flowchart for explaining the method according to the present invention.

FIG. 4 shows a sketch of a vehicle equipped with a driver-assistance system.

### DETAILED DESCRIPTION OF THE INVENTION

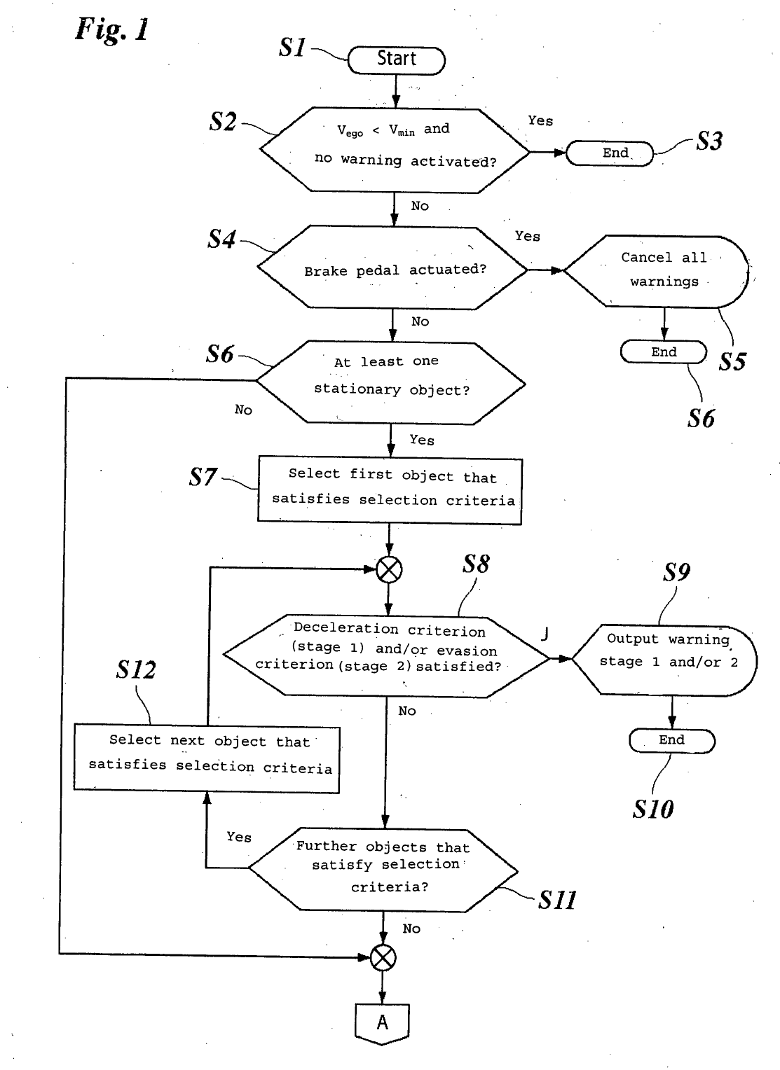

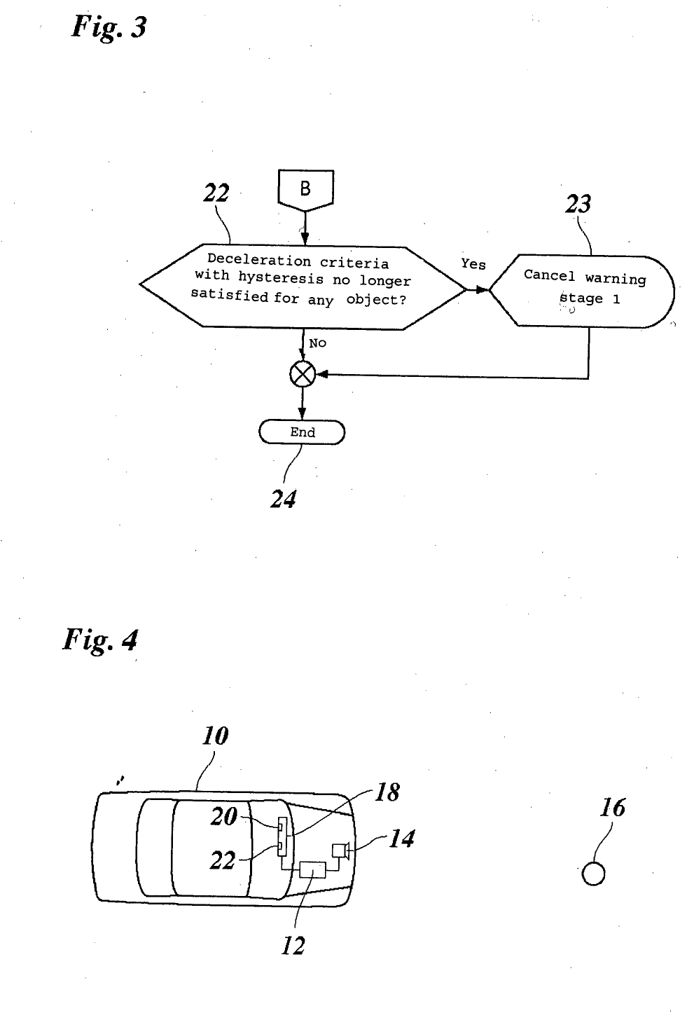

The flowchart shown in FIGS. 1 through 3 illustrates a collision-warning function, by which a driver of a motor vehicle 10 (FIG. 4), depending on the situation, is warned of a possible obstacle in two warning stages. The warning, function is implemented as a program in an electronic control unit 12 that typically is part of a driver-assistance system, for instance, an ACC system. The assistance system is assigned a locating system, for instance, a radar system 14, by which distances, relative velocities and azimuth angles of objects 16 in front of vehicle 10 are located. This data, possibly after suitable preprocessing in the ACC system, is also available to the warning function. The one signal device 18 is provided with two signal transmitters 20, 22 for output of the warning signal.

The algorithm described by the flowchart is started periodically, e.g., in synchronism with the measuring cycle of the radar system, with step S1 in FIG. 1. In step S2, it is then checked whether absolute velocity V_{ego} of the host vehicle is less than a predefined minimum velocity Vₘᵢₙ. If this condition is satisfied, then the velocity of vehicle 10 is so low that the triggering of a new collision warning would be neither necessary nor useful. If a warning stage has not already been activated before, the procedure is ended with step S3.

If one of the two conditions checked in step S2 is not satisfied, then in step S4, it is checked whether the brake pedal of the vehicle is actuated. The actuation of the brake pedal indicates that the driver has already recognized the danger situation and has reacted accordingly. In this case, in step S5, all warning stages possibly already activated are canceled, and with step S6, the procedure is ended, so that no further checks take place and no warning is implemented.

If the ACC system is not active during the operation of the warning function described here, and therefore the driver is controlling the vehicle velocity himself using the accelerator, as a condition equivalent to the condition that the brake pedal is actuated, it could also be checked in step S4, whether the driver has released the accelerator or has temporarily deactivated the (distance-independent) cruise controller, in order to trigger a deceleration of the vehicle.

If the result of the check in step S4 is negative, in step S6 it is checked whether the locating system has located at least one stationary object. If one or more stationary objects have been located, then they are put into a list, e.g., arranged according to increasing distances, and their plausibility is checked based on a number of selection criteria. A first selection criterion is that the object must be within the traffic lane of the host vehicle. Objects in adjacent lanes or away from the roadway are therefore discarded. A second selection criterion is that the distance of the object in question is smaller than a predefined maximum distance. Thus, the system is prevented from responding to objects that are very far away, from which no serious danger yet comes and whose interpretation is still very uncertain.

Further selection criteria are used for determining whether the object is a relevant obstacle. If at least one preceding vehicle is located at the same time, the trajectory of this vehicle is compared to the location of the object. If, in so doing, it turns out that the preceding vehicle has driven over the object, it can then be deduced that the object is not a relevant obstacle, and it is discarded.

According to a further selection criterion, the history of the stationary object is evaluated. The object located in the instantaneous measuring cycle can be identified with the object which was located in previous cycles based on the known relative velocity. If, in so doing, it turns out that the locating of the object is not stable, that is, that measurement interruptions have occurred with a certain frequency, then it may be deduced that it is a relatively small object which generates only a weak and unstable reflection signal, and therefore does not represent a large relevant obstacle. The object is discarded in this case, as well.

Even if the object was located stably in the past, according to a further selection criterion, it is checked whether there have been abrupt changes in the lateral position of this object (calculated from the azimuth angle of the radar signal). In this case, the object is also discarded as irrelevant. A typical example is the case where the supposed obstacle is an expansion joint, running transversely over the roadway, which generates a radar echo. In this case, for the most part abrupt changes in the lateral position appear in the locating data, which would not be expected for a real obstacle.

As a simplified example, it shall be assumed here that the checking of the selection criteria in each case leads to a yes/no statement; thus, the object is either accepted or rejected. A conceivable variant, however, could be to assign to the object a multiple-valued plausibility parameter which, the higher it is, the greater the probability that a real object is involved. The value of this plausibility parameter would then have an influence on the selection of threshold values in the checking of deceleration and evasion criteria described further below.

In step S7, the first object is selected from the list of stationary objects that satisfy all selection criteria. For this object, it is then checked in step S8 whether it satisfies a deceleration criterion and/or an evasion criterion.

Expressed briefly, the deceleration criterion says that deceleration a of the host vehicle which would be necessary in order to avoid a collision with the object in question or to maintain a sufficient safety distance to the object is greater than a specific threshold value.

For example, deceleration a may be calculated according to the following formula:

a=(½)(v²/d)

In this formula, v is the relative velocity (v=−V_{ego} is true for stationary objects), and d is the measured object distance, possibly reduced by a desired safety distance, which should be maintained at any rate. If desired, deceleration a may also be multiplied by a suitable “safety factor.”

Alternatively, the calculation is carried out according to the formula:

a=(½)(v²/(d−vtᵣ))

Here, tᵣ is a delay time that is made up, for example, of the reaction time of the driver and a system reaction time for the response of the brake system.

While the calculation methods indicated above are based solely on kinematic and dynamic considerations, alternatively, an empirical approach is also possible in which the typical behavior of human drivers is modeled. For example, deceleration a may then be calculated according to the following formula:

a=v((1/t_{c})+(Δtₛ/(TΔtᵢ))

Here, t_{c} is the precalculated time until the collision, calculated, for instance, under the assumption that the (positive or negative) absolute acceleration of the host vehicle will remain constant, Δtᵢ is the instantaneous time gap between the object and the host vehicle (Δtᵢ=d/v), Δtₛ is a setpoint time gap which the driver has selected for the operation of the ACC system, and T is an empirically determined time constant. Time constant T may be determined in test drives, for instance, in which the test drivers take over the vehicle guidance (with deactivated ACC system), and the time gaps, velocities and accelerations occurring upon approaching an obstacle are recorded.

Naturally, the setpoint time gap set at the ACC system may also be utilized when the ACC system is deactivated. Alternatively, a standard value may also be assumed for Δtₛ, or a time average may be formed from the time gaps with which the driver follows a preceding vehicle when the ACC system is deactivated. The greater setpoint time gap Δtₛ is, the greater is calculated acceleration a, and all the more likely the deceleration criterion will be satisfied when a is compared to the corresponding threshold value. The term 1/t_{c} ensures that, given constant deceleration a, the vehicle will come to a standstill at the latest upon reaching the object.

In the case of all three calculation methods described above, the threshold value to which a is compared is either predefined in a fixed manner, or is variable as a function of certain parameters, e.g., as a function of setpoint time gap Δtₛ. The greater the setpoint time gap selected by the driver, then the smaller the threshold value, and accordingly all the more likely the deceleration criterion will be satisfied.

If the deceleration criterion is satisfied, in step S9, a first warning stage is activated, e.g., in the form of an indicator on a display (signal transmitter 20) on the dashboard.

The evasion criterion, which likewise is checked in step S8, says that the difference between the time until the collision and the time which would probably be needed for an evasive maneuver is less than a predetermined threshold value. If the difference is greater than the threshold value, sufficient time is therefore still available for an evasive maneuver, and a certain safety reserve still remains.

The time needed for the evasive maneuver is calculated in that, based on plausible assumptions for the possible lateral acceleration of the vehicle (dependency on the absolute velocity), an evasive course is calculated which brings the host vehicle to an adjacent lane or at least makes it possible to drive around the obstacle without danger. If desired, the reaction time of the driver and system-inherent response delays are taken into account when calculating the evasive course, as well. The length of the evasive course is then divided by host-vehicle velocity V_{ego}.

Analogous to the threshold value for the deceleration criterion, the threshold value may be a function of setpoint time gap Δtₛ, or may be determined on the basis of empirically ascertained parameters.

The threshold values for the deceleration criterion and the evasion criterion may be coordinated in such a way that in the normal case, the threshold value for the deceleration criterion is exceeded first. If the evasion criterion is satisfied, as a rule the deceleration criterion will therefore also be satisfied. If the evasion criterion is satisfied or (in a modified specific embodiment) if both criteria are satisfied at the same time, in step S9, a second warning stage is activated, and the driver receives a more emphatic warning sign through signal transmitter 22, e.g., by a blinking signal light, a warning tone or the like. Thereupon, the procedure is ended with step S10.

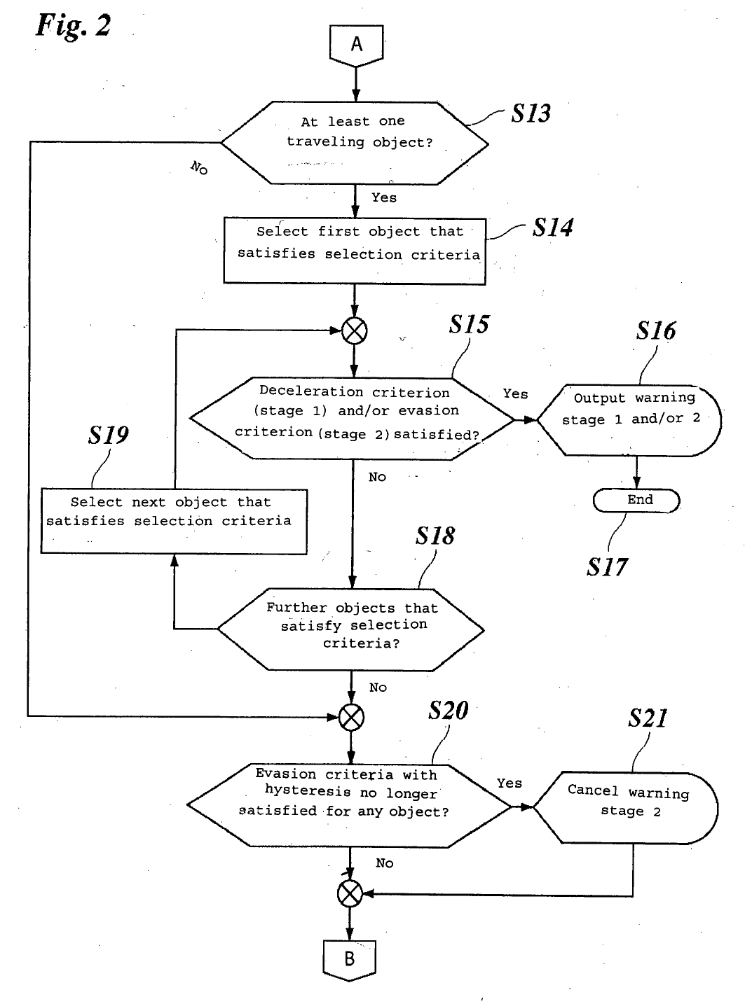

If the result in step S8 is that neither of the two criteria is satisfied, in step S1 it is checked whether the list contains still further stationary objects that satisfy the selection criteria, and if this is the case, in step S12 the next object is selected and the procedure branches back to step S8. Steps S8, S11 and S12 are then repeated in a loop until the loop is left via step S9 or all stationary objects in the list are processed. In the latter case, the procedure is continued with step S13 in FIG. 2. If no stationary objects were located (step S6), steps S7 through S12 are skipped, and the procedure is likewise continued with step S13.

Steps S13 through S19 in FIG. 2 are analogous to steps S6 through S12 in FIG. 1, but now relate to moving (traveling) objects. The check of the selection criteria in step S14 is less extensive here and, in the simplest case, is restricted to checking whether the object is in the traffic lane of the host vehicle, as well as, optionally, checking whether the object distance is less than the maximum distance. The deceleration and evasion criteria checked in step S15 are analogous to the criteria described above for stationary objects, however different threshold values and parameters may be provided here. In addition, these criteria take into account the circumstance that moving objects are involved, so that their absolute velocity and possibly absolute acceleration must also be taken into consideration.

If the loop having steps S15, S18 and S19 has been completely processed and therefore no warning has been output, in step S20, at least the stationary and moving objects which have induced a warning in step S9 or step S16 in one of the previous cycles are checked as to whether they also still satisfy the evasion criterion in question (step S8 or step S15) when the threshold value for the time difference between the time up to the collision and the time for the evasive maneuver has been reduced in the sense of a hysteresis. If, taking the hysteresis into consideration, the criterion itself is no longer satisfied, then in step S21, the second warning stage is canceled, so that instead of the more urgent warning signal, only the milder warning signal of the first stage is output to the driver.

Following step S20 or S21, in analogous manner, for the objects which have triggered warning stage 1 in the past, it is then checked in step S22 whether the deceleration criterion is still satisfied, again using a modified threshold value for deceleration a, which in this case is increased in the sense of a hysteresis. If the deceleration criterion with hysteresis is no longer satisfied, then in step S23, warning stage 1 is also canceled. The program cycle is subsequently ended with step S24, and a new cycle is started at a given time with step S1. Owing to the hysteresis in steps S20 and S22, the driver is prevented from becoming irritated and stressed due to a frequent change between the first and the second warning stage.

If, in step S2, it is determined that the velocity of the vehicle has decreased below Vₘᵢₙ, but one of the two warning stages is still active, then the routine is continued so that in step S21 or in step S23 the respective warning stage can be canceled if the danger situation has neutralized. On the other hand, if the velocity of the host vehicle increases again above Vₘᵢₙ, the respective warning stage therefore remains active. In this way, a frequent change of the warning signals output to the driver is also avoided if the velocity fluctuates around Vₘᵢₙ.

1-13. (canceled)

14. A method for warning a driver of a host motor vehicle of a danger of collision with at least one target object located in front of the host motor vehicle in a traffic lane occupied by the host motor vehicle, comprising:
checking a deceleration criterion relating to a deceleration of the host motor vehicle necessary for avoiding the collision with the at least one target object;
checking an evasion criterion relating to a time needed for performing an evasive maneuver of the host motor vehicle relative to an estimated time remaining until the collision with the at least one target object;
activating a first warning stage if only one of the deceleration criterion and the evasion criterion is satisfied for the at least one target object; and
activating a second warning stage if both the deceleration criterion and the evasion criterion are satisfied for the at least one target object.

15. The method as recited in claim 14, wherein the at least one target object is one of a moving object and a stationary object.

16. The method as recited in claim 14, wherein a stationary object is excluded from consideration as the at least one target object if a plurality of measurement interruptions has previously appeared in the locating signal of the stationary object.

17. The method as recited in claim 14, wherein a stationary object is excluded from consideration as the at least one target object if abrupt changes have previously occurred in the lateral position of the stationary object.

18. The method as recited in claim 14, wherein at least one of the checking of the deceleration criterion and the checking of the evasion criterion includes a comparison to a threshold value, and wherein the threshold value is determined as a function of a parameter one of: a) adjusted by the driver; and b) calculated on the basis of a characteristic feature in the driver behavior.

19. The method as recited in claim 18, wherein the parameter is a set-point time gap determining a distance at which a preceding vehicle is followed in the framework of a distance-control function.

20. The method as recited in claim 14, wherein the checking of the deceleration criterion includes a calculation of a vehicle deceleration value necessary for avoiding the collision and a comparison of the vehicle deceleration value to a threshold value, and wherein at least one of the deceleration value and the threshold value is calculated as a function of an empirically determined parameter representing the behavior of a human driver.

21. The method as recited in claim 14, wherein the checking of the evasion criterion includes: a) a calculation of a first time period representing a remaining time period until the collision without an evasive maneuver; b) a calculation of a second time period necessary for an evasive maneuver; c) a calculation of a difference between the second time period and the first time period; and d) a comparison of the difference between the second time period and the first time period to a threshold value.

22. The method as recited in claim 21, wherein the threshold value is determined as a function of a parameter one of: a) calculated by the driver; and b) calculated on the basis of empirical data concerning the behavior of a human driver.

23. The method as recited in claim 14, wherein the first warning stage is activated when the deceleration criterion is satisfied, and wherein the second warning stage is activated when the evasion criterion is also satisfied.

24. The method as recited in claim 14, wherein a first warning signal is output to the driver so long as the first warning stage is active, and wherein a second warning signal more intense than the first warning signal is output to the driver when the second warning stage is activated.

25. The method as recited in claim 24, wherein one of the first warning stage and the second warning stage is switched off when the requisite condition for activating the one of the first warning stage and the second warning stage is no longer satisfied.

26. A device for warning a driver of a host motor vehicle of a danger of collision with at least one target object located in front of the host motor vehicle in a traffic lane occupied by the host motor vehicle, comprising:
a locating system for locating the at least one target object in front of the vehicle;
a control device configured to perform:
checking a deceleration criterion relating to a deceleration of the host motor vehicle necessary for avoiding the collision with the at least one target object;
checking an evasion criterion relating to a time needed for performing an evasive maneuver of the host motor vehicle relative to an estimated time remaining until the collision with the at least one target object;
activating a first warning stage if only one of the deceleration criterion and the evasion criterion is satisfied for the at least one target object; and
activating a second warning stage if both the deceleration criterion and the evasion criterion are satisfied for the at least one target object; and
a signal device configured to output warning signals to the driver, wherein the signal device has a first signal transmitter for a first warning signal generated when the first warning stage is active and a second signal transmitter for a second warning signal generated when the second warning stage is active, and wherein the second warning signal is more intense than the first warning signal.
